(19) United States
(12) Patent Application Publication
(10) Pub. No.: US 2025/0073666 A1
(43) Pub. Date: Mar. 6, 2025

(54) Broad-Spectrum HC/VOC Getter for Emission Control in Electronics

(71) Applicants: hua Xia, Huffman, TX (US); David DeWire, Superior, CO (US)

(72) Inventors: hua Xia, Huffman, TX (US); David DeWire, Superior, CO (US)

(21) Appl. No.: 18/953,025

(22) Filed: Nov. 19, 2024

(51) Int. Cl. B01J 20/16; B01D 53/14; B01D 53/44; B01D 53/82

(52) U.S. Cl. CPC B01J 20/16; B01D 53/1487; B01D 53/44; B01D 53/82; B01D 2252/10; B01D 2257/702; B01D 2257/708; B01D 2258/02

(57) ABSTRACT

Getters for hydrocarbons (HCs) and volatile organic compounds (VOCs) designed for microelectronic and electronic packages are disclosed. These getters feature a hierarchical porous nanostructured polymer composite layer supported by a substrate. The composite layer integrates hydrophilic microporous nanoparticles and hydrophobic mesoporous nanoparticles, enabling the modulation of hydrophilic and hydrophobic properties. This tailored structure facilitates the effective absorption of a broad spectrum of polar and non-polar HCs and VOCs, for enhancing the reliability and performance of electronic packages by controlling outgassed emissions.

### FIELD OF THE INVENTION

This invention relates to polymer getter composites designed to capture a broad spectrum of hydrocarbons (HCs) and volatile organic compounds (VOCs) emitted from microelectronic and electronic packages, devices, and modules. More specifically, it pertains to hierarchical porous nanostructured polymer composites that incorporate hydrophilic micropores and hydrophobic mesopores, enabling efficient absorption of both polar and non-polar HCs and VOCs released during manufacturing or throughout the operational lifespan of the device.

### BACKGROUND

The reliability of electronic devices is frequently compromised by the outgassing of various gases and volatile compounds during manufacturing or operation. These emissions encompass a wide range of polar and non-polar substances, including non-polar gases such as hydrogen (H₂), oxygen (O₂), carbon monoxide (CO), carbon dioxide (CO₂), and nitrogen (N₂); polar gases like water vapor (H₂O), non-polar HCs such as methane (CH₄), benzene (C₆H₆), toluene (C₇H₈), and xylene (C₈H₁₀); and polar VOCs like acetone (C₃H₆O), ethanol (C₂H₆O), and formaldehyde (CH₂O). These emissions typically originate from packaging materials, including polymers, epoxies, adhesives, and thermal interface materials. For instance, silicone and epoxy-based thermal interface materials may release polar acetone (CH₃COCH₃), non-polar toluene (C₇H₈), and xylene (C₈H₁₀). Adhesives and soldering fluxes used in printed circuit board (PCB) assembly can emit polar isopropanol (C₃H₈O), acetone (CH₃COCH₃), and non-polar benzene (C₆H₆). Similarly, RF/MW absorbents designed to mitigate electromagnetic interference (EMI) often outgas non-polar toluene (CH₈), xylene (C₈H₁₀), and polar acetone (CH₃COCH₃).

These emissions arise from the intrinsic chemical properties of packaging materials, which volatilize under manufacturing or operational condition. For example, polyimide—a widely used material in flexible circuit boards, adhesives, and coatings—can emit acetone, formaldehyde, benzene, toluene, xylene, and methanol. Polymethyl methacrylate (PMMA), commonly found in optical components, may release acetone, methanol, and butanone. Similarly, silicones used in sealants and encapsulants can outgas siloxanes, acetone, methanol, toluene, and xylene. Beyond HCs and volatile VOCs, hermetically sealed packaging materials can also release gases such as water vapor (H₂O), nitrogen (N₂), hydrogen (H₂), carbon monoxide (CO), carbon dioxide (CO₂), and oxygen (O₂).

The emission of polar and non-polar HCs/VOCs from packaging materials can significantly impact the reliability of electronic packages. These gases can contaminate sensitive components like microelectronics, sensors, and optics, degrading performance or causing failure. HCs/VOCs, especially acidic or moisture-reactive ones, may corrode metal contacts or leads, leading to short circuits, increased resistance, or intermittent connections, reducing device longevity. They can also degrade insulating polymers, compromising dielectric properties and increasing the risk of electrical breakdown. Outgassing may introduce contaminants into the sealed package, potentially creating conductive paths or damaging microstructures. Additionally, HCs/VOCs can weaken bonding materials, leading to failure or mechanical stresses. Condensation on heat-dissipating surfaces can reduce thermal efficiency, causing overheating or damage. To mitigate these risks, it is crucial to select low-outgassing materials or incorporate getters to neutralize these emissions.

Current getter technologies, including those based on 3A zeolite, palladium (Pd), titanium (Ti), and zirconium alloys, exhibit limitations in addressing the diverse range of emissions from electronic packaging. While certain combinations—such as 3A zeolite doped with PdO for capturing moisture and hydrogen or 4A or 5A zeolites for moisture and VOCs—offer targeted functionality, they generally lack the versatility needed to adsorb the full spectrum of polar and non-polar HCs and VOCs. Polymer-based getters incorporating 3A zeolites effectively adsorb polar molecules like water vapor but perform poorly against non-polar molecules, such as H₂, N₂, and O₂. Likewise, zirconium-alloy based non-evaporable getters doped with metal oxides (e.g., Fe, Al, Co, Ti, or rare earth elements) may adsorb limited quantities of polar and non-polar gases but fail to adequately mitigate the wide variety of emissions encountered. Over time, the accumulation of these emissions can compromise device performance, leading to issues such as voltage instability, leakage currents, corrosion, reduced electrical insulation, and diminished thermal dissipation.

The challenges posed by the emission of HCs/VOCs in electronic packages are significant, but they often go under-addressed for several reasons, even though solutions do exist. The range of potential emissions from packaging materials is diverse, making it difficult to pinpoint specific solutions. Developing effective solutions to scavenge or neutralize HCs/VOCs in a way that doesn't compromise the performance of the package (e.g., by introducing additional materials or complicating manufacturing) can be costly and time-consuming. While there are solutions available, such as getters or absorbents, many of them have limitations in terms of effectiveness, cost, or ease of integration into existing manufacturing processes.

The adsorption capabilities of current getter materials are highly variable and often restricted to specific emission types. For instance, palladium (Pd) and titanium (Ti) effectively absorb hydrogen through hydride formation but are ineffective against moisture and other gases. Zeolites are well-suited for capturing small polar molecules like water vapor and carbon dioxide but cannot adsorb non-polar gases such as hydrogen, nitrogen, or oxygen, nor can they address non-polar HCs and VOCs. These limitations highlight the need for a versatile getter material that can simultaneously adsorb both polar and non-polar compounds, ensuring comprehensive protection for electronic devices against emissions-related degradation.

Hierarchical porous nanostructured composites have emerged as highly effective materials for adsorbing both polar and non-polar hydrocarbons (HCs) and volatile organic compounds (VOCs). These composites integrate networks of micropores and mesopores, working together to enhance adsorption performance. Microporous nanoparticles, with pore diameters under 2 nm, act as molecular sieves with strong polar interactions and hydrophilic properties, making them excellent for adsorbing polar gases. In contrast, mesoporous nanoparticles, with pore sizes between 2 nm and 50 nm, are hydrophobic, allowing efficient adsorption of non-polar gases while also facilitating the diffusion of both polar and non-polar molecules into the micropores for absorption.

Hydrophilic microporous nanoparticles, such as aluminosilicates, silica gel, activated carbon, and metal-organic frameworks (MOFs), are highly effective at adsorbing polar gases due to their strong polar interaction. Aluminosilicates, with their low silicon-to-aluminum (Si/Al) ratios and polar silicon hydroxyl groups (Si—OH), excel in this role. Similarly, silica gel, enriched with hydrophilic silanol groups (Si—OH), and activated carbon, featuring a dense microporous structure, are excellent choices for polar gas adsorption. MOFs, composed of metal ions and organic linkers, provide customizable pore sizes and adaptable adsorption properties, making them versatile solutions for various gases absorptions.

Hydrophobic mesoporous nanoparticles, such as silica aerogels, can be functionalized with surface groups like trimethylsilyl (TMS) or fluoroalkylsilane compounds, enhancing their efficiency in adsorbing non-polar gases. Activated carbon, naturally hydrophobic, can be tailored with mesoporous structures to improve its capacity for non-polar gas adsorption. Similarly, mesoporous silica/zeolite materials modified with alkyl or fluoroalkyl groups and pure-silica zeolites, such as silicalite-1 and ZSM-5, exhibit strong affinities for non-polar molecules. With their high surface areas, high Si/Al ratio, and low densities, these materials are particularly suited for capturing large, non-polar compounds.

Combining hydrophilic microporous nanoparticles with hydrophobic mesoporous nanoparticles creates a hierarchical porous nanostructure. The mesopores enable rapid transport and diffusion of molecules to the micropores, which selectively adsorb smaller polar molecules. Fabrication typically involves in-situ polymerization or a sol-gel process, where hydrophilic molecular sieve particles are physically mixed with hydrophobic mesoporous nanoparticle precursors, followed by gelation and drying. The resulting composite features hybrid architecture, with each component contributing to improved adsorption performance for HCs and VOCs.

This invention overcomes the limitations of existing getter technologies by introducing a hierarchical porous nanostructured polymer composite that efficiently captures a broad spectrum of both polar and non-polar HCs/VOCs. The mesopores facilitate the absorption of larger non-polar HCs/VOCs, while the micropores selectively adsorb smaller polar HCs/VOCs. This synergistic composite ensures effective adsorption of various emissions, regardless of polarity or molecular size, offering a reliable solution for managing outgassing in electronic packages without compromising device performance. One of the primary objectives of this invention is to provide a single, multi-functional getter capable of replacing the current multiple single-functional getters.

### SUMMARY OF THE INVENTION

The terms “invention,” “the invention,” “this invention,” and “present invention” refer collectively to all subject matter disclosed herein, including the claims. Similarly, the terms “polymer composite” and “gettering material” are used interchangeably, as are “hierarchical porous nanostructured polymer composite” and “hierarchical porous nanostructured composite” The term “HC/VOC Getter” specifically describes a getter designed to adsorb both polar and non-polar multi-gas emissions, such as HCs and VOCs. Additionally, the terms “multi-gas” and “a broad spectrum of HCs/VOCs” are considered synonymous. Statements incorporating these terms are not intended to restrict the described subject matter or limit the scope of the claims. The claims define the embodiments of the invention, while this summary provides a general overview and does not identify required features or determine claim scope, which should be interpreted in the context of the entire specification, drawings, and claims.

This invention introduces a hierarchical porous nanostructured polymer composite designed to adsorb both polar and non-polar emissions, particularly hydrocarbons (HCs) and volatile organic compounds (VOCs), which are often released by packaging materials in hermetically sealed microelectronic or electronic packages. The composite is composed of hydrophilic microporous nanoparticles and hydrophobic mesoporous nanoparticles, co-embedded within a polymer matrix such as polyimide, silicone RTV, or polyvinyl alcohol (PVA), forming a structure optimized for efficient adsorption of these emissions.

In one embodiment, the hierarchical porous nanostructured composite incorporates microporous nanoparticles with pore sizes smaller than 2 nm, which act as molecular sieves for the adsorption of polar molecules. In another embodiment, the composite includes mesoporous nanoparticles with pore sizes ranging from 2 nm to 50 nm, serving as pathways for small molecules and enabling the efficient adsorption of larger non-polar molecules. In a further embodiment, the composite features a polymer matrix—either hydrophobic polyimide (PI) or silicone, or hydrophilic polyvinyl alcohol (PVA)—which ensures thermal stability and compatibility with the nanoparticles across a wide temperature range (−200° C. to 350° C. for PI, −55° C. to 200° C. for Silicone, and −50° C. to 150° C. for PVA) while also providing limited adsorption capacity for both polar and non-polar HCs and VOCs.

The composite's adsorption performance is driven by the synergistic interaction between microporous and mesoporous nanoparticles co-embedded within the polymer matrix. Hydrophilic polymers, such as PVA, improve the retention of polar molecules but may hinder accessibility to non-polar emissions. Conversely, hydrophobic polymers like silicone or polyimide repel water and other polar molecules, prioritizing the capture of non-polar species while reducing the adsorption of polar molecules. This carefully calibrated balance mitigates the competitive adsorption effects of polar and non-polar species on getter surfaces, ensuring efficient capture across a broad spectrum of emissions.

The invention employs a ternary diagram to design hierarchical porous nanostructured composites with tailored hydrophilic or hydrophobic properties by adjusting the ratios of hydrophilic microporous nanoparticles and hydrophobic mesoporous nanoparticles. In one embodiment, for packages emitting predominantly polar species, the polymer composite primarily incorporates hydrophilic microporous nanoparticles. In another embodiment, for packages emitting predominantly non-polar species, the polymer composite primarily incorporates hydrophobic mesoporous nanoparticles. In a further embodiment, for mixed emissions, a balanced composition of hydrophilic microporous and hydrophobic mesoporous nanoparticles co-embedded within a polymer matrix is optimized to achieve comprehensive adsorption capabilities.

In one embodiment, the grain sizes of microporous nanoparticles in the polymer composite are less than 100 nm, while the grain sizes of mesoporous nanoparticles are less than 100 nm. In another embodiment, the hierarchical porous nanostructured polymer composite consists of 20-60 wt % microporous nanoparticles, 20-60 wt % mesoporous nanoparticles, and 20-50 wt % polymers. In a further embodiment, a hydrophilicity-dominant composite exhibits a strong absorption capacity for polar HCs/VOCs but relatively weaker absorption for non-polar HCs/VOCs. Conversely, a hydrophobicity-dominant composite demonstrates superior absorption of non-polar HCs/VOCs while being less effective for polar species. In yet another embodiment, a balanced ratio of hydrophilic and hydrophobic components creates an optimized hierarchical porous nanostructured composite capable of capturing both polar and non-polar HCs/VOCs with nearly equal efficiency.

The polymer composite composition involves the physical blending of hydrophilic microporous nanoparticles and hydrophobic mesoporous nanoparticles, forming a hierarchical porous nanostructure within a polymer matrix. In one embodiment, the microporous nanoparticle material exhibits high hydrophilicity. In another embodiment, the mesoporous nanoparticle material exhibits high hydrophobicity. In a further embodiment, the polymer composite has high surface energy, primarily enabling effective absorption of polar HCs and VOCs through its hydrophilic and sieving properties. In yet another embodiment, the polymer composite has low surface energy, primarily facilitating effective absorption of non-polar HCs/VOCs through its hydrophobic properties.

The invention also encompasses a getter based on a polymer composite, consisting of a polymer composite layer and a substrate. In one embodiment, the polymer composite includes 30-40 wt % microporous nanoparticles, 30-40 wt % mesoporous nanoparticles, and 30-40 wt % polymers, providing balanced adsorption capabilities for both polar and non-polar HCs/VOCs absorption. In another embodiment, the composite contains 50-60 wt % microporous nanoparticles and 10-20 wt % mesoporous nanoparticles, tailored for applications focused on polar HCs/VOCs absorption. In a further embodiment, the polymer composite comprises 10-20 wt % microporous nanoparticles and 50-60 wt % mesoporous nanoparticles, optimized for non-polar-focused absorptions. In yet another embodiment, the polymer composite comprises 0-70 wt % microporous nanoparticles and 0-70 wt % mesoporous nanoparticles, and 30-50 wt % polymers, optimized for specific gases absorptions.

The fabrication of hierarchical porous nanostructured polymer composites can be achieved through various methods, ensuring uniform nanoparticle dispersion, robust interfacial bonding, and retention of the hierarchical pore structure. In one embodiment, an in-situ polymerization technique is employed, where the polymer matrix forms directly around the nanoparticles. In another embodiment, the sol-gel processing method is utilized, particularly effective for integrating mesoporous particles into polymers such as silicone and polyimide. In a further embodiment, 3D printing is applied, enabling precise shaping and structuring of composites while maintaining the hierarchical pore configuration.

The primary goal of this invention is to develop hierarchical porous nanostructured polymer composites capable of adsorbing the broad spectrum of polar and non-polar HCs and VOCs, emitted from microelectronic or electronic packages, devices, and modules.

Another objective is to offer a multifunctional getter that can replace the existing multiple single-functional getters, capable of capturing a wide range of polar and non-polar HCs and VOCs outgassed from microelectronic or electronic packages, devices, and modules.

This summary outlines the design, materials, and fabrication methods for HCs and VOCs getters, along with the invention's objectives, without limitations. Full details of the disclosure can be found in the entire document, accompanying figures, and claims.

### BRIEF DESCRIPTION OF THE DRAWINGS

Aspects of the present disclosure are best understood from the following detailed description when read with the accompanying figures. But these descriptions and drawings are illustrative and are not to be construed as limiting. Numerous specific details are described to provide a thorough understanding of the disclosure. However, in certain instances, well-known details are not described in order to avoid obscuring the description. Further, various getter design modifications may be made without deviating from the scope of the embodiments. The invention will be further illustrated with the help of the following figures where:

FIG. 1 presents a ternary (or triple) diagram used to visualize and analyze the polymer composition, which includes the three components of micropores, mesopores, and polymers, as detailed in the description.

FIG. 2 shows cross-sectional views of various embodiments of a HCs/VOCs getter featuring a polymer composite layer applied to both sides of a substrate, in accordance with the invention.

FIG. 3 depicts cross-sectional views of a HCs/VOCs getter featuring a polymer composite layer applied to one side of a substrate, according to the invention.

FIG. 4 illustrates cross-sectional views of a HCs/VOCs getter featuring a polymer composite layer applied to the outer surface of a thin metal wire, as described in the invention.

FIG. 5 is the absorption capacities of hierarchical porous nanostructured composites, as described in the invention.

FIG. 6 is the absorption capacities from binary polymer composites from polar and non-polar HCs/VOCs emissions, as described in the invention.

### DETAILED DESCRIPTION OF INVENTION

The embodiments described in this disclosure are illustrative examples and are not meant to be limiting. While they represent specific implementations, various alternative forms and materials may be used. Thus, the structural and functional details provided should serve as a guide for those skilled in the art to apply and adapt the principles of this disclosure. It is understood that features shown in any figure may be combined with those from other figures to create embodiments not explicitly detailed. Modifications and combinations of features consistent with this disclosure's teachings may be adapted to meet specific applications or requirements.

Conventional microelectronic and electronic packages, devices, and modules release a range of polar and non-polar contaminants due to outgassing from materials such as polymers, epoxies, adhesives, absorbents, and thermal interface materials (TIMs). These emissions, characterized by either polar or non-polar properties, occur during thermal processing, environmental exposure, and long-term aging. Polymers and epoxies primarily outgas polar compounds, such as ketones, alcohols, and aldehydes, especially during curing or at elevated temperatures. Adhesives release both polar species (e.g., amines, acids) and non-polar species (e.g., hydrocarbons, siloxanes), depending on their chemical composition. TIMs may emit non-polar siloxanes and other polar residues, while absorbents often release polar molecules like residual water or alcohols.

The distinction between HCs and VOCs is context-dependent: hydrocarbons refer specifically to compounds composed only of carbon and hydrogen, while VOCs encompass a broader category that includes any organic compound capable of easy volatilization, which may include hydrocarbons. Non-polar HCs and non-polar VOCs share similar molecular structures and properties. Both are predominantly composed of carbon (C) and hydrogen (H), lack significant polar functional groups, and exhibit weak intermolecular forces such as van der Waals forces. Volatility is a shared characteristic between non-polar HCs and non-polar VOCs because of the weak intermolecular forces they exhibit. Non-polar HCs, such as methane, ethane, propane, and butane, consist solely of C—H and C—C bonds. Their symmetric structures cancel any dipole moments, resulting in a non-polar nature. Similarly, non-polar VOCs, including alkanes, some alkenes, alkynes, and aromatic hydrocarbons, also consist of C—H and C—C bonds. While they may feature large structures or cyclic/aromatic forms, the absence of polar functional groups ensures their non-polarity.

A hierarchical porous nanostructured polymer composite, engineered for the efficient absorption of both polar and non-polar gases, HCs, and VOCs, is synthesized by co-embedding hydrophilic microporous nanoparticles with hydrophobic mesoporous nanomaterials into a selected polymer matrix. This composite is designed to absorb a broad spectrum of HCs and VOCs. While materials such as zeolites, PdO, Pd, Ti, Zr—Fe, Zr—Al, activated carbons, polymers, and metal oxides are commonly used to scavenge gases like H₂, H₂O, CO₂, N₂, and O₂, they often prove ineffective in capturing HCs and VOCs. Furthermore, to achieve efficient capture of a wide range of emitted species with a single-functional getter remains challenging, particularly for both polar and non-polar gases. Even more so, capturing a diverse range of HCs and VOCs with a single functional getter proves difficult.

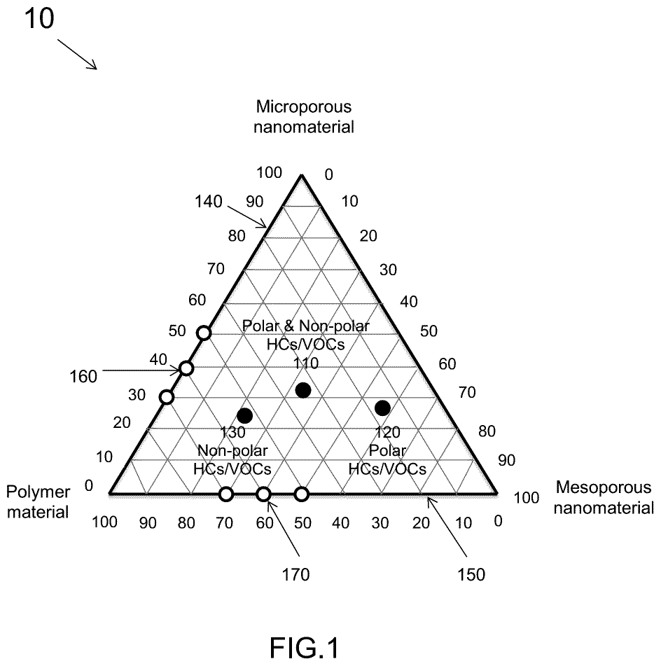

The hierarchical porous nanostructured polymer composite, as depicted in FIG. 1, utilizes a “Ternary Diagram” to visualize and analyze the composition and adsorption properties of its three components. This diagram illustrates gas absorption capabilities based on the composition, with each point on the diagram corresponding to a specific ratio of the three components, reflecting their hydrophilicity or hydrophobicity. For instance, certain regions of the diagram emphasize compositions that improve the adsorption of specific gases, such as balanced polar and non-polar HC/VOC composites (110), polar HC/VOC composites (120), non-polar HC/VOC composites (130), and binary composites 140 and 150. This provides guidance for selecting the optimal composition to scavenge particular gases from electronic packages. The composite's composition can be fine-tuned by adjusting the hydrophilicity or hydrophobicity or by altering the ratio of microporous and mesoporous nanoparticles in the hierarchical porous nanostructures, targeting specific areas of the diagram for tailored applications.

### Hydrophilicity and Hydrophobicity Balanced HCs/VOCs Getter

Consider a polymer composite engineered to capture both polar and non-polar emissions in electronics packages, featuring a balanced hydrophilic and hydrophobic nature. This composite may consist of 30-40 wt % microporous nanoparticles, 30-40 wt % hydrophobic mesoporous nanoparticles, and 30-40 wt % polymers with respect to the total composite composition, positioned within the “Polar/Nonpolar HCs/VOCs” region 110 in FIG. 1. It is estimated to absorb 6-10 wt % of nonpolar hydrocarbons (such as alkanes and aromatic compounds like benzene, toluene, and xylene) and 4-9 wt % of polar VOCs (e.g., alcohols like methanol and ethanol, ketones like acetone, and small organic acids).

The hydrophobic mesoporous nanoparticles enable the absorption of nonpolar hydrocarbons through van der Waals forces, typically achieving hydrocarbon absorption capacities of 20-30% of their own weight. For a composite containing 33 wt % mesoporous nanoparticles, this translates to an approximate 6.6-10% absorption capacity for hydrocarbons in the overall composite. Similarly, the hydrophilic microporous nanoparticles are highly effective at capturing polar HCs/VOCs due to their strong affinity for polar molecules. With a polar VOC absorption range of 10-25% by weight, the 33 wt % content of microporous nanoparticles can contribute an estimated 3.3-8.3% VOC absorption in the composite. Polyvinyl Alcohol (PVA), while having a lower individual absorption capacity, further aids in polar VOC capture due to its hydrophilic nature. It typically absorbs 2-5% of its weight in VOCs, adding an additional 0.6-1.65% to the overall VOC absorption capacity of the composite. This brings the estimated total polar VOC absorption range to approximately 4-9 wt % of the polymer composite's total weight.

An alternative approach involves using a polyimide matrix with the same component ratios. The hydrophilic microporous nanoparticle material within this matrix is particularly effective at absorbing polar VOCs, owing to its polar surface sites and porous structure, which are ideal for small, polar molecules such as methanol, acetone, ethanol, and acetonitrile. Its absorption capacity for these compounds can reach 20-30% of its own weight. Although the hydrophilic microporous nanoparticle material can also capture smaller non-polar hydrocarbons like methane, its polar surface properties make it more selective for polar VOCs.

In contrast, the hydrophobic mesoporous nanoparticle material is highly efficient at absorbing non-polar VOCs, such as benzene, toluene, xylene, and alkanes, due to its hydrophobic nature, which favors non-polar molecules. This component typically has an absorption capacity for non-polar VOCs in the range of 15-25% of its own weight. Polyimides, while offering a modest absorption capacity for both polar and non-polar VOCs, contribute versatility. Polyimides possess polar functional groups that attract polar molecules but are relatively hydrophobic, allowing them to absorb non-polar hydrocarbons as well. They generally absorb about 2-8% of their weight in VOCs, with a slight preference for non-polar VOCs. In this polyimide-based composite, the estimated total absorption capacity for non-polar HCs and VOCs (such as alkanes, benzene, and toluene) is approximately 20-25% of the composite's weight, primarily due to the hydrophobic mesopores and, to a lesser extent, the polyimide. For polar VOCs (e.g., methanol, acetone), the hydrophilic micropore component provides an absorption capacity of around 10-15% of the composite's weight.

Another approach is to use a silicone RTV matrix to create a similar composite material. This design achieves comparable absorption capacities for both polar and non-polar HCs and VOCs, similar to composites based on PVA and polyimide polymers. The hydrophilic microporous nanoparticle material is especially effective at adsorbing small polar molecules such as methanol, ethanol, acetone, and acetonitrile, with an absorption capacity that can reach 20-30% of its weight. While it can also absorb smaller non-polar hydrocarbons like methane, it has a stronger preference for polar compounds.

The hydrophobic mesoporous nanoparticle material in this composite, known for its high surface area and non-polar surface characteristics, is highly effective at adsorbing non-polar VOCs. It can absorb up to 15-25% of its weight in non-polar VOCs, such as alkanes and aromatic hydrocarbons, although it has limited affinity for polar VOCs. The silicone RTV polymer itself, being relatively hydrophobic, offers moderate absorption capacity for non-polar VOCs like long-chain alkanes and aromatics, including benzene, toluene, and xylene, typically absorbing 2-8% of its weight in these compounds, with slightly lower absorption for polar VOCs. In this silicone RTV-based composite, the estimated total absorption capacity for non-polar VOCs (such as alkanes, benzene, and toluene) is around 20-25% of the composite's weight, primarily due to the hydrophobic mesoporous nanoparticles and RTV polymer. The hydrophilic microporous nanoparticle component contributes an absorption capacity of approximately 10-15% of the composite's weight for polar VOCs (e.g., methanol, acetone). These absorption capacities may vary depending on the specific HCs/VOCs, as well as environmental factors such as temperature, humidity, VOC concentration, and the composite's physical properties.

Besides PVA (Polyvinyl Alcohol), silicone, and polyimide, there are several other polymer matrix materials suitable for composites with embedded nanoparticles, offering a broad operating temperature range at least from −55° C. to 200° C. These include hydrophilic epoxy resins, hydrophobic polyurethane (PU), hydrophobic polyetheretherketone (PEEK), slightly from hydrophilic to hydrophobic polycarbonate (PC), hydrophobic polytetrafluoroethylene (PTFE), and hydrophobic Fluoropolymers (e.g., PVDF, FEP). Each of these polymers, along with PVA, silicone, and polyimide, provides distinct advantages depending on the specific hydrophilicity/hydrophobicity requirements of the composite.

Getters that balance hydrophilic and hydrophobic properties, using various polymers such as PVA, polyimide, and silicone RTV, have demonstrated similar absorption capacities for both polar and non-polar HCs and VOCs, even when operating across different temperature ranges. In high-humidity environments, hydrophilic microporous nanoparticles effectively adsorb moisture and polar HCs/VOCs, while hydrophobic mesoporous nanoparticles continue to excel in absorbing non-polar HCs and VOCs. In single-material getters, adsorbents may become saturated with one type of molecule (e.g., water in hydrophilic zeolite), reducing their efficiency in capturing other target HCs and VOCs. By combining hydrophilic and hydrophobic adsorbents, these composites help mitigate cross-interference between polar and non-polar emissions. This balanced approach distributes the adsorption load, lowering the likelihood of any one component saturating too quickly. As a result, the getter achieves a longer effective lifespan and enhanced stability, with each component selectively adsorbing its compatible molecules without interference. Furthermore, the polymer matrix (e.g., silicone RTV, PVA, or polyimide) contributes to the overall stability of the composite by providing elasticity and preventing pore collapse under high-humidity or high-temperature conditions, ensuring the structural integrity and long-term adsorption efficiency of the material.

### Hydrophilicity-Dominant HCs/VOCs Getter

Even after a bakeout process and hermetic sealing, an electronics package can continue to outgas polar-dominated HCs/VOCs. A composite with hydrophilic dominance is ideal for capturing these polar emissions, as shown in the “Polar HCs/VOCs” 120 region of FIG. 1. A suitable composition might consist of 50-60 wt % hydrophilic microporous nanoparticles, 10-20 wt % hydrophobic mesoporous nanoparticles, and 25-35 wt % PVA polymers with respect to the total composite composition. This blend enables effective adsorption of polar VOCs, such as:
Ethanol (C₂H₅OH): Up to 10-15% of the hydrophilic microporous material's weight, or approximately 5.5-8.25% of the composite's total weight.
Formaldehyde (CH₂O): Up to 5-10% of the hydrophilic microporous material's weight, or 2.75-5.5% of the composite's weight.
Acetone (CH₃COCH₃): Around 5-10% of the hydrophilic microporous material's weight, contributing 2.75-5.5% to the composite.
Acetic acid (CH₃COOH): Up to 10% of the hydrophilic microporous material's weight, adding around 5.5% to the composite.
   Additionally, the composite is capable of adsorbing some non-polar HCs via the hydrophobic mesoporous nanoparticles, including:
Benzene (C₆H₆): Up to 10% of the hydrophobic mesoporous material's weight, contributing about 1.5% to the composite.
Toluene (C₆H₅CH₃): 10-15% of the hydrophobic mesoporous material's weight, or 1.5-2.25% of the composite.
Hexane (C₆H₁₄): About 5-10% of the hydrophobic mesoporous material's weight, or 0.75-1.5% of the composite.
Xylene (C₈H₁₀): Up to 10% of the hydrophobic mesoporous material's weight, providing around 1.5% of the composite.
   This hydrophilic-dominant composite is highly effective at capturing polar-dominated HCs and VOCs, while also offering some capacity for absorbing non-polar compounds.

By substituting PVA polymer with silicone RTV polymer, the composite retains a composition of 25-35 wt % silicone RTV, 50-60 wt % hydrophobic mesoporous nanoparticle material, and 10-20 wt % hydrophilic microporous nanoparticle material with respect to the total composite composition. The hydrophilic microporous nanoparticles effectively adsorb small alcohols (e.g., ethanol, methanol), acetone, acetic acid, and oxygenated hydrocarbons like formaldehyde. The absorption capacity for small alcohols typically ranges from 10-25% of the hydrophilic microporous material's weight, depending on vapor pressure and temperature. Acetone and acetic acid are absorbed at approximately 10-20% of the hydrophilic microporous material's weight, driven by polarity interactions. Formaldehyde is absorbed at around 10-15% of the hydrophilic microporous material's weight, slightly less than larger polar VOCs.

The composite also adsorbs non-polar HCs and VOCs, such as benzene, toluene, xylene, hexane, and other alkanes and aromatics, through the hydrophobic mesoporous nanoparticles and with some contribution from the silicone RTV matrix. The absorption capacity for benzene, toluene, and xylene by the hydrophobic mesoporous material is up to 10-15% of its weight, while for hexane and other alkanes can reach up to 5-10%. This hydrophobic-dominant composite provides strong performance for capturing non-polar-dominated HCs and VOCs, with additional capacity for some polar HCs and VOCs absorption.

To explore further, the composite is modified by replacing silicone RTV with polyimide polymer, while maintaining a composition of 25-35 wt % polyimide, 50-60 wt % hydrophilic microporous nanoparticle material, and 10-20 wt % hydrophobic mesoporous nanoparticle material. This revised composite is designed to target the absorption of small polar alcohols (ethanol, methanol), acetone, formaldehyde, acetic acid, and other polar oxygenated hydrocarbons. The expected absorption capacity for ethanol and methanol ranges from 10-25% of the composite's weight, driven by strong polarity-based interactions. For acetone and acetic acid, the absorption capacity is about 10-20% of the hydrophilic microporous nanoparticle material's weight, as these molecules interact effectively with the polar surface of the material. Formaldehyde absorption is estimated at up to 10-15% of the weight of the microporous nanoparticle material.

In terms of non-polar HCs and VOCs, the composite is designed to absorb benzene, toluene, xylene, hexane, heptane, and other non-polar alkanes and aromatics. These compounds are primarily adsorbed by the hydrophobic mesoporous nanoparticle material, with additional support from the polyimide matrix for certain non-polar substances. The estimated absorption capacity for benzene, toluene, and xylene (BTX) is around 10-15% of the hydrophobic mesoporous nanoparticle material's weight due to van der Waals interactions. For non-polar alkanes like hexane and heptane, the combined absorption capacity of the hydrophobic mesoporous material and polyimide is estimated at 5-10% of the total weight. This hydrophilicity-dominant composite offers strong performance in capturing polar-dominated HCs and VOCs, with additional capacity for absorbing some non-polar compounds.

A hydrophilic-dominant composite featuring hydrophilic microporous nanoparticle material is highly effective at absorbing moisture and polar gases. This composite performs well in humid environments, continuously capturing moisture and preventing pore clogging, which helps maintain its adsorption capacity. With high microporous content, it is optimized for polar contaminant adsorption, yet still performs adequately in non-polar environments due to the presence of limited hydrophobic components, such as mesopores. The hydrophilic surface of the microporous material selectively adsorbs specific polar gases, while minimizing the capture of non-polar contaminants, like hydrocarbons. Additionally, the combination of hydrophilic micropores and hydrophobic mesopores enables the composite to handle both polar and non-polar contaminants. The hydrophilic micropores target polar HCs/VOCs, while the hydrophobic mesopores focus on non-polar substances, resulting in a versatile hierarchical porous nanostructure that addresses a broad spectrum of contaminants.

### Hydrophobicity-Dominant HCs/VOCs Getter

A hydrophobic-dominant polymer composite, designed to capture non-polar gases from electronics packages as shown in the “Non-Polar HCs/VOCs” area 130 of FIG. 1, is composed of 25-35 wt % polymer (such as PVA), 10-20 wt % hydrophilic microporous nanoparticle material, and 50-60 wt % hydrophobic mesoporous nanoparticle material with respect to the total composite composition. The hydrophilic microporous nanoparticle material effectively adsorbs various polar HCs and VOCs, including ammonia, acetone, methanol, as well as small non-polar molecules like propane and butane. The hydrophobic mesoporous nanoparticle material, however, preferentially absorbs non-polar or low-polarity HCs and VOCs, such as benzene, toluene, and xylene (BTX), along with other non-polar HCs like hexane and heptane. PVA, which is polar and contains hydroxyl (—OH) groups, enhances the composite's ability to capture polar compounds through hydrogen bonding and dipole-dipole interactions. This allows PVA to absorb polar VOCs, like alcohols (e.g., methanol, ethanol), and oxygenated VOCs, such as aldehydes (e.g., formaldehyde, acetaldehyde), although with moderate capacity due to its relatively lower surface area compared to nanoporous materials. The absorption capacities for polar VOCs such as methanol and ethanol are 5-10 wt %, for acetone 4-8 wt %, and for formaldehyde 6-12 wt %, mainly due to the combined adsorption by PVA and microporous nanoparticle material. In contrast, the absorption capacities for non-polar VOCs like benzene, toluene, and xylene (BTX) are 10-20 wt %, while hexane and heptane absorb 8-15 wt %, primarily driven by the hydrophobic mesopores.

In a silicone RTV-based hydrophobic composite consisting of 30 wt % silicone RTV, 15 wt % hydrophilic microporous nanoparticle material, and 55 wt % hydrophobic mesoporous nanoparticle material, the absorption capacities for various polar and non-polar HCs and VOCs are influenced by the chemical affinity and surface area of each component. Silicone RTV, a hydrophobic material with a siloxane backbone, exhibits a moderate affinity for non-polar VOCs through van der Waals interactions. Based on the individual contributions of each component, the approximate absorption capacities for polar VOCs are:
Methanol (CH₃OH) and Ethanol (C₂H₆O): 4-9 wt %, primarily absorbed by the hydrophilic microporous material.
Acetone (C₃H₆O): 3-7 wt %, mainly absorbed by the hydrophilic microporous material.
Formaldehyde (CH₂O): 5-10 wt %, predominantly captured by the hydrophilic microporous material, which has a strong affinity for polar molecules.
   For non-polar VOCs, the approximate absorption capacities are:
Benzene (C₆H₆), Toluene (C₇H₈), and Xylene (BTX) (C₈H₁₀): 12-25 wt %, mainly absorbed by the hydrophobic mesoporous material, with some contribution from the silicone RTV.
Hexane (C₆H₁₄) and Heptane (C₇H₁₆): 10-18 wt %, primarily absorbed by the hydrophobic mesoporous material.
   Although the absorption capacity of silicone RTV is relatively limited compared to highly porous materials, it provides stability to the composite.

To further investigate the composite, replacing PVA with polyimide results in a material comprising 30 wt % polyimide, 15 wt % microporous nanoparticles, and 55 wt % hydrophobic mesoporous nanoparticles. The absorption capacities for various polar and non-polar HCs/VOCs are influenced by the unique characteristics of each component. Polyimide, known for its thermal stability and moderate polarity, has relatively low inherent porosity but can interact with polar and aromatic hydrocarbons through pi-stacking and dipole interactions. While its VOCs absorption capacity is limited compared to more porous materials, polyimide contributes structural support and stability across a wide temperature range.

The absorption capacities for various VOCs in this composite are as follows:
Methanol and Ethanol (Polar VOCs): 5-10 wt %, primarily absorbed by hydrophilic micropores, which has a strong affinity for polar molecules due to its ionic structure.
Acetone (Polar VOC): 4-8 wt %, mainly absorbed by hydrophilic micropores.
Formaldehyde (Polar VOC): 6-12 wt %, predominantly captured by hydrophilic micropores, which has a high affinity for small polar molecules.
Benzene, Toluene, and Xylene (BTX) (Non-Polar VOCs): 12-25 wt %, primarily absorbed by hydrophobic mesopores, which has a strong affinity for non-polar and aromatic hydrocarbons.
Hexane and Heptane (Non-Polar VOCs): 10-18 wt %, mainly absorbed by hydrophobic mesopores.
   These absorption capacities may vary based on external temperature, humidity, and VOCs partial pressure. However, these general values reflect the expected behavior of the composite, where hydrophilic micropores predominantly handles polar VOCs, hydrophobic mesopores is responsible for non-polar VOC absorption, and polyimide provides structural integrity across a broad temperature range.

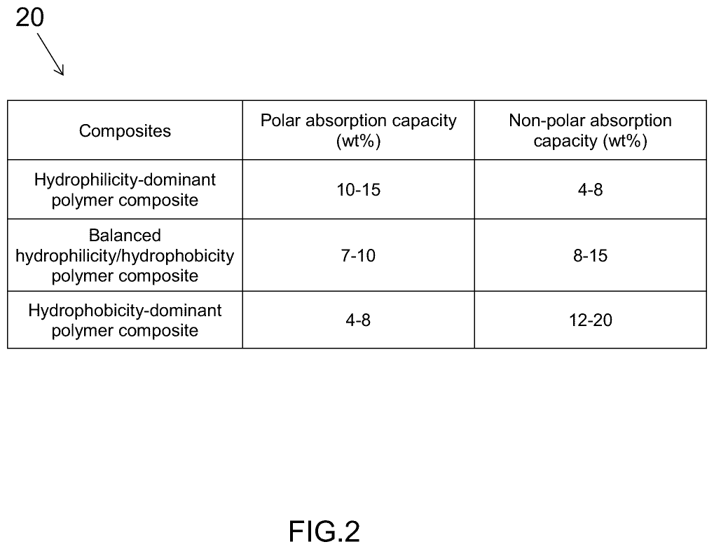

FIG. 2 provides a summary of the total absorption of polar and non-polar HCs and VOCs by hierarchical porous nanostructured composites, each incorporated into different polymer matrices (PVA, silicone RTV, and polyimide). The balanced hydrophilicity/hydrophobicity composite offers moderate adsorption of both polar and non-polar VOCs, making it versatile and suitable for a variety of HCs/VOCs emissions. The hydrophilicity-dominant composite excels in absorbing polar VOCs, making it ideal for environments with high concentrations of polar HCs and VOCs. The hydrophobicity-dominant composite, with its high mesopore content, is best suited for non-polar VOCs and moisture-resistant applications. These absorption capacity comparisons can help guide the selection of the most appropriate composite for specific HCs/VOCs environments and desired absorption characteristics.

### Hydrophilic and Hydrophobic Binary HCs/VOCs Getter

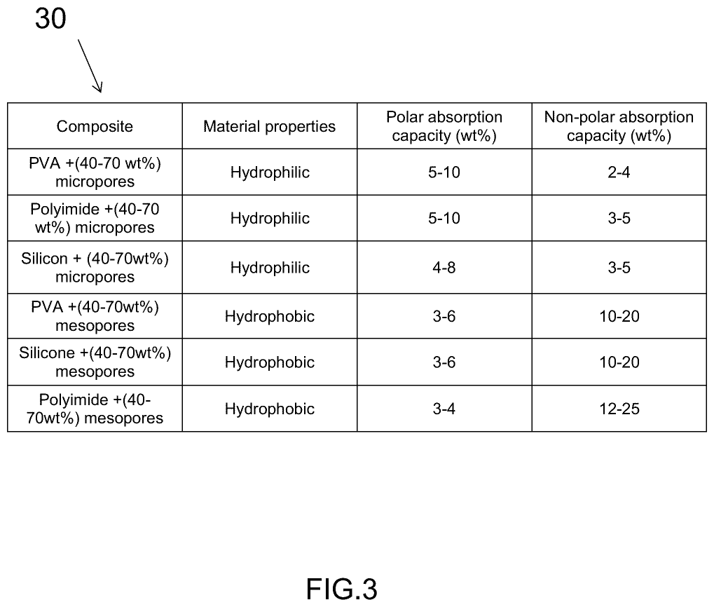

When working with a triple-component polymer composite (such as PVA, silicone RTV, or polyimide) combined with microporous and mesoporous nanoparticles, removing either the micropores or mesopores component results in binary composites with unique absorption properties for polar and non-polar HCs and VOCs. For instance, a common 70:30 ratio (microporous nanoparticle material to polymer) is used in binary composites to emphasize the adsorption of polar VOCs, while still maintaining the structural support and flexibility provided by the polymer. Alternatively, a 60:40 ratio (microporous nanoparticle material to polymer) may be chosen when additional polymer is needed for improved mechanical properties, such as in thicker films or when greater flexibility is required. Binary polymer composites 140, 150 are illustrated in FIG. 1, where the polymer is combined with one of the two other components to form binary composites 160 and 170. FIG. 3 presents the predicted absorption capacities for both polar and non-polar HCs/VOCs by these binary polymer composites. Polymer+micropore composites are highly effective at absorbing polar HCs and VOCs, owing to the micropores strong affinity for polar molecules. On the other hand, polymer+mesopore composites are optimized for non-polar HCs and VOCs, leveraging the high surface area and hydrophobic nature of the mesopores. The choice between these binary composites depends on the target HCs/VOCs and the specific absorption capacity required for polar or non-polar compounds in the application. By comparing the absorption capacities in FIGS. 2 and 3, it becomes clear that the selection of the polymer composite is influenced by the application's unique needs.

To fabricate a hierarchical porous composite with hydrophilic microporous nanoparticles and hydrophobic mesoporous nanoparticles co-embedded in a polymer matrix (such as PVA, silicone RTV, or polyimide), several fabrication techniques can be used to ensure uniform dispersion, strong interfacial bonding, and retention of the hierarchical pore structure. Practical methods include:
In-Situ Polymerization: This technique involves forming the polymer matrix directly around the nanoparticles, suitable for PVA, silicone RTV, and polyimide.
Sol-Gel Processing: Effective for incorporating mesoporous particles into polymers like silicone RTV and polyimide.
3D Printing: An additive manufacturing technique that allows for precise shaping of composites with hierarchical pore structures.
   Each method provides distinct benefits, depending on the polymer system, the desired composite's properties, and manufacturing cost considerations.

The polymer composite designs based on the triple diagram (FIG. 1) can feature varying ratios of three components or binary components. While increasing the polymer content (PVA, silicone, or polyimide) can improve the processability of the composite, it may reduce the adsorption efficiency. Ideally, the polymer content should not exceed 50 wt %, as it must be sufficient to bind the microporous nanoparticle material, provide flexibility, and enhance handling and mechanical properties. However, excessive polymer content, particularly PVA, can limit the available surface area for adsorption, thereby decreasing the composite's overall adsorption capacity.

The coefficient of thermal expansion (CTE) and density of a polymer composite can be estimated using the effective medium approximation method. For example, if a composite is made of 33 wt % PVA polymer, 33 wt % microporous nanoparticle material, and 33 wt % mesoporous nanoparticle material, the properties of the individual components can be combined using rule-of-mixtures approximations and known values.

The CTE of the composite is typically estimated as a weighted average of the CTE values of the individual components, adjusted by their volume fractions:

$$CTE = ( cmposite ) \sum ( {CTE}_{i} * {V}_{i} ) , \qquad ( 1 )$$

where CTEi represents the thermal expansion of each component (CTE (PVA)=70-110×10⁻⁶/° C., CTE (micropores)=3−5×10⁻⁶/° C., CTE (mesopores)=1-3×10⁻⁶/° C.), and vi=33% is the volume fraction of each component. The estimated CTE is approximately 19×10⁻⁶/° C., which is closer to the lower range of PVA due to the dominance of mesopore low thermal expansion.
   Similarly, the density of the composite is calculated as a weighted average based on the mass fractions and densities of the components:

$$\frac{1}{{ρ}_{composite}} = \sum ( \frac{{V}_{i}}{{ρ}_{i}} ) , \qquad ( 2 )$$

where ρᵢ is the density of each component (PVA density=˜1.19 g/cm³, microporous nanoparticle material density=˜2.0 g/cm³, and mesoporous nanoparticle material density=˜0.1 g/cm³). The resulting composite density is approximately 0.27 g/cm³.
   Both the thermal expansion and density of the composite will vary depending on the ratios of the microporous and mesoporous nanoparticle materials, as well as the selected polymers.

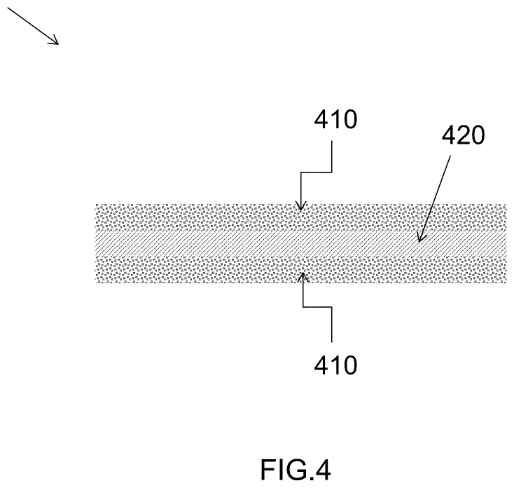

FIG. 4 illustrates a getter 40 produced using a layer-by-layer coating technique, such as brushing or spraying. In this process, polymer composite slurry is applied to both sides of a substrate, forming a polymer composite layer 410. The substrate can be a thin slab of borosilicate glass, Kovar, or aluminum alloy 420. In the cross-sectional view, the getter 40 includes the polymer composite layer 410, the substrate 420. This getter 40 can function as a compact passive component within an electronic package, with the polymer composite layer 410 specifically designed to adsorb HCs/VOCs emitted from the packaging materials.

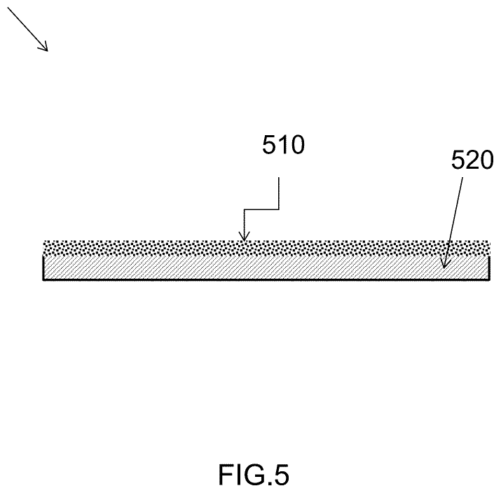

FIG. 5 illustrates a getter 50 produced using a layer-by-layer coating method, such as brushing or spraying, where a polymer composite slurry is applied to one side of the substrate to form the polymer composite layer 510. The substrate 520 may be a thin slab of borosilicate glass, Kovar, or aluminum alloy. In the cross-sectional view, the structure of the getter 50 includes the polymer composite layer 510, the substrate 520. This getter 50 can serve as a compact component within an electronic package. The polymer composite layer 510 is designed to capture HCs and VOCs released from the packaging. Polar HCs and VOCs are adsorbed onto the microporous nanoparticles on the surface of the polymer composite layer, then, diffuse into the subsurface porous structures, where they are further adsorbed within the boundaries and interior walls of the microporous nanoparticles. Similarly, non-polar HCs/VOCs are adsorbed onto the mesoporous nanoparticles on the polymer composite layer surface, diffuse into the subsurface nanoporous structures, and are adsorbed within the boundaries and interior walls of the mesoporous nanoparticles. There is no competition or interference between polar and non-polar HCs/VOCs for adsorption sites on the surface. While the polymer matrix may adsorb some polar and non-polar HCs/VOCs, its absorption capacity is relatively low compared to the nanoporous materials.

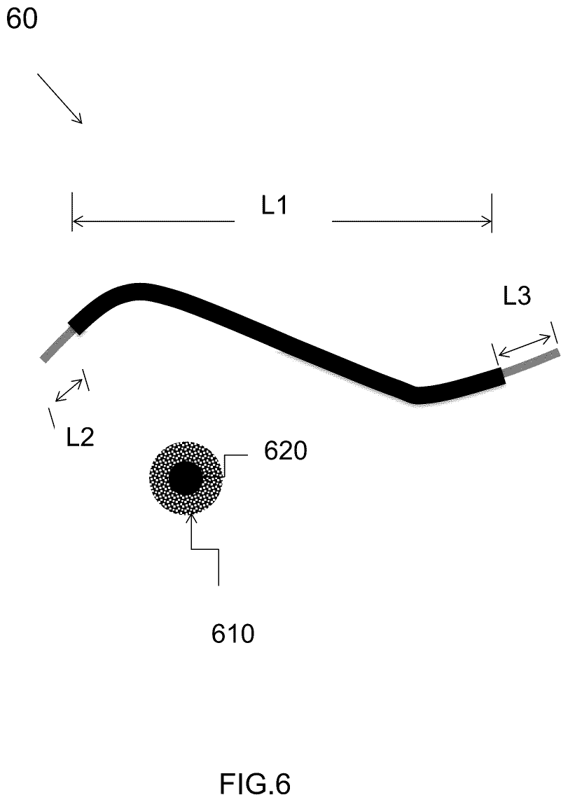

FIG. 6 illustrates a getter 60 fabricated using a layer-by-layer coating method, such as brushing or spraying. In this design, a composite slurry solution is applied to the outer surface of a metal wire substrate 610, which may be made from thin copper, titanium, nickel, or other alloys that provide a good thermal expansion match with the polymer composite. The cross-sectional view reveals the structure of the getter 60, including the polymer composite layer 620, and the wire substrate 610. This getter 60 functions as a compact wire-like component within an electronic package. It can be soldered to PCBs as a non-electrical component, embedded in the interior walls of a package, or attached to the inner surface of a hermetic lid. The length of the metal wire (L1) can be customized to meet specific application requirements, while the lengths of the exposed leads (L2, L3) can be adjusted for PCB soldering needs. The wire's diameter can range from as small as 100 μm to several millimeters, depending on the intended application.

The gas adsorptive layer 620 is designed to capture HCs/VOCs released from the package. Polar HCs/VOCs outgassed from the package are adsorbed onto the microporous nanoparticles on the surface of the polymer composite layer, then diffuse into the subsurface porous structures and bind to the internal walls of the microporous nanoparticles. Similarly, non-polar HCs/VOCs are adsorbed onto the mesoporous nanoparticles on the surface of the polymer composite layer, diffuse into the nanoporous structures, and adsorb within the boundaries and internal walls of the mesoporous nanoparticles.

To estimate the adsorption capacity of a composite material with ternary components, the following approach combines theoretical estimates, experimental data, and material properties:

### 1. Define Adsorption Mechanism:

Hydrophilic microporous nanoparticles adsorb polar HCs/VOCs through molecular sieving interactions.
Hydrophobic mesoporous nanoparticles adsorb non-polar HCs/VOCs due to their high surface area and hydrophobic nature.
The polymer provides structural integrity but plays a minor role in adsorption.

### 2. Calculate Specific Adsorption Capacity for Each Component:

Microporous nanoparticle adsorption:

$$Q ( polar HCs / VOCs ) = A ( micropores ) \times S ( polar HCs / VOCs ) \qquad ( 3 )$$

where A (micropores) is the mass fraction of microporous nanoparticles in the composite, and S (polar HCs/VOCs) is the adsorption capacity of microporous nanoparticles for the specific polar HCs/VOCs.
Mesoporous nanoparticle adsorption:

$$Q ( non - polar HCs / VOCs ) = A ( mesopores ) \times S ( non - polar HCs / VOCs ) \qquad ( 4 )$$

where A (mesopores) is the mass fraction of mesoporous nanoparticles in the composite, and S (non-polar HCs/VOCs) is the adsorption capacity of mesoporous nanoparticles for the specific non-polar HCs/VOCs.
Polymer adsorption:

$$Q ( poloymer ) = A ( poloymer ) \times S ( poloymer ) \qquad ( 5 )$$

where A (polymer) is the mass fraction of polymer in the composite, and S (polymer) is its adsorption capacity for specific polar and non-polar HCs/VOCs.
3. Total adsorption capacity:
The total adsorption capacity of the composite is the sum of the contributions from each component, calculated as:

$$Q ( total ) = \sum A ( i ) \times Si ( i ) , i = 1 , 23 \qquad ( 6 )$$

where A(i) represents the mass fraction of each component (micropores, mesopores, and polymer) and S(i) represents the adsorption capacity of each component for the respective HCs/VOCs.
   This approach enables the estimation of the composite's total adsorption capacity based on the mass fractions and adsorption properties of each component.

The method can be illustrated through an example calculation for CO₂ (a non-polar gas), benzene (non-polar HCs/VOCs), and methanol (a polar HCs/VOCs) in a composite with 30 wt % hydrophilic microporous nanoparticle material, 30 wt % hydrophobic mesoporous nanoparticle material, and 40 wt % PVA polymer:
1. Hydrophilic micropores adsorption (for CO₂):
   Adsorption capacity of hydrophilic micropores for CO₂: ˜10 mg/g.
   Micropores content in composite: 30 wt %.
   Adsorption capacity from micropores for CO₂:

Q(CO₂,micropores)=0.30×10=3 mg CO₂ per g
For a getter with a total mass of 150 mg, the CO₂ adsorption capacity is 0.45 mg (0.3 wt %).
2. Hydrophobic mesopores adsorption (for Benzene):
   Adsorption capacity of mesopores for benzene: ˜200 mg/g.
   Mesopores content in composite: 30 wt %.
   Adsorption capacity from mesopores for benzene:

Q(benzene,mesopores)=0.30×200=60 mg benzene per g composite
For a getter with a total mass of 150 mg, the benzene adsorption capacity is 9 mg (6 wt %).
3. PVA Adsorption (for Methanol):
   Adsorption capacity of PVA for methanol: ˜10 mg/g by its hydrophilicity.
   PVA content in composite: 40 wt %.
   Adsorption capacity from PVA for methanol:

Q(methanol,PVA)=0.40×10=4 mg methanol per g composite
For a getter with a total mass of 150 mg, the methanol adsorption capacity is 0.6 mg (0.4 wt %).
4. The total adsorption capacity is calculated as:

Q(total)=Q(CO₂,micropores)+Q(benzene,mesopores)+Q(methanol,PVA)=67 mg of adsorbates per g composite

For a getter with a total mass of 150 mg, the adsorption capacity is 10.05 mg (6.7 wt %). This example demonstrates that the composite material, with these mass fractions and adsorption characteristics, can adsorb 10.05 mg of non-polar CO₂, non-polar HCs/VOCs benzene, and polar HCs/VOCs methanol per 150 mg getter, with a size of 2.54×2.54×0.025 cm³. This method can be applied to calculate adsorption capacities for other HCs and VOCs as well.

To design an effective HCs/VOCs getter for absorbing outgassed HCs and VOCs from a package, device, or module, it is essential to estimate the potential amount of HCs/VOCs that could be outgassed, ensuring the getter has an adequate safety margin. In conventional microelectronics and electronics packages, outgassed HCs/VOCs typically originate from materials such as adhesives, coatings, encapsulants, solder pastes, fluxes, and printed circuit board (PCB) components. These emissions may result from thermal processing during manufacturing, environmental exposure, or long-term aging within the package. Below are some common outgassed HCs/VOCs, along with their approximate weight percentages:

### Common Outgassed HCs and VOCs in Electronics Packages

1. Alkanes and Cycloalkanes (0.01-0.2 wt %)
   Examples: Methane, ethane, propane, and cyclohexane
   Sources: Organic encapsulants, adhesives, or polymer degradation
2. Aromatic Hydrocarbons (0.01-0.3 wt %)
   Examples: Benzene, toluene, xylene
   Sources: Epoxy resins, adhesives, and some plasticizers used in packaging materials
3. Alcohols (0.01-0.15 wt %)
   Examples: Methanol, ethanol, isopropanol
   Sources: Solvents from solder fluxes, PCB cleaning agents, adhesive residuals
4. Ketones (0.005-0.1 wt %)
   Examples: Acetone, methyl ethyl ketone (MEK)
   Sources: Residual solvents in adhesives, PCB laminates, and cleaning processes
5. Esters (0.01-0.2 wt %)
   Examples: Methyl acetate, ethyl acetate
   Sources: Residues from adhesives, cleaning agents, and flux materials
6. Acids (0.005-0.05 wt %)
   Examples: Acetic acid, formic acid
   Sources: Outgassing from certain solder fluxes, adhesives, and degradation of organic materials
7. Siloxanes (0.005-0.1 wt %)
   Examples: Hexamethylcyclotrisiloxane, octamethylcyclotetrasiloxane
   Sources: Silicone-based encapsulants, conformal coatings, RTV silicones
8. Amines and Amides (0.005-0.05 wt %)
   Examples: Methylamine, dimethylamine, acetamide
   Sources: Curing agents and additives in epoxies and coatings
9. Other VOCs
   Formaldehyde, styrene, and phthalates may also outgas in low amounts (0.001-0.05 wt %) from various plasticizers, resins, and stabilizers.

Several factors impact the amount of outgassed HCs and VOCs in electronics packages. First, the package's operating temperature, soldering temperature, and bakeout process during assembly can significantly accelerate the emission of HCs and VOCs. Second, the material composition plays a crucial role, as the type of polymer, solvent, and additives used in the package directly influence the types and quantities of VOCs released. Third, environmental conditions such as humidity, temperature cycling, and exposure to oxygen can further contribute to outgassing.

For a package that has undergone a comprehensive bakeout process at elevated temperatures for an adequate duration, the total outgassed quantity can be as low as 0.05 wt % of the overall package material. For example, if the total weight of packaging materials, including wires, PCBs, RF/MW absorbents, TIMs, and other electronic components, is approximately 10 g, the potential outgassing of HCs and VOCs would be around 0.005 g (5 mg).
To capture this, a HC/VOC getter with dimensions of 2.54 cm×2.54 cm×0.025 cm and an adsorption capacity of 10 mg would provide adequate containment. However, for high reliability, it is recommended to select and install a getter with a safety factor at least three to five.

What is claimed is:

1. A getter designed to capture outgassed hydrocarbons (HCs) and volatile organic compounds (VOCs) from microelectronic or electronic packages, devices, or modules, comprising:
a polymer composite layer; and
a substrate.

2. The getter of claim 1, wherein the polymer composite layer includes:
at least one polymer matrix material; and
at least one gas absorptive material.

3. The getter of claim 1, wherein the polymer composite layer features a hierarchical porous nanostructure.

4. The getter of claim 3, wherein the hierarchical porous nanostructure comprises hydrophilic microporous nanoparticles and hydrophobic mesoporous nanoparticles, co-embedded within a selected polymer matrix.

5. The getter of claim 2, wherein the gas-adsorptive material is selected from aluminosilicates, including 3A, 4A, 5A, and 13X zeolites, as well as zeolite X, zeolite Y, zeolite A, beta-zeolite, and natural zeolites, with micropore sizes ranging from 0.3 nm to 2.0 nm and with Si/Al ratio close to 1.

6. The getter of claim 2, wherein the gas adsorptive material is selected from silica aerogels, silicalite-1, ZSM-5 with Si/Al ratio greater than 100, mesoporous silica (SBA-15, MCM-41), and activated carbon, with mesopore sizes ranging from 2 nm to 50 nm.

7. The getter of claims 1-2, wherein the polymer matrix material is selected from the group consisting of polyvinyl alcohol (PVA), silicone RTV, polyimide (PI), epoxy resins, polyurethane (PU), polyetheretherketone (PEEK), polycarbonate (PC), polytetrafluoroethylene (PTFE), and fluoropolymers (e.g., PVDF, FEP), with an operating temperature range of at least −40° C. to 120° C., and more preferably from −55° C. to 200° C.

8. The getter of claims 1-3, wherein the hierarchical porous nanostructured composite comprises ternary components including 20-60 wt % hydrophilic microporous nanoparticles, 20-60 wt % hydrophobic mesoporous nanoparticles, and 20-50 wt % polymer matrixes, with respect to the total composite composition.

9. The getter of claims 1-3, wherein the hierarchical porous nanostructure comprises binary components consisting of 0-70 wt % hydrophilic microporous nanoparticles, 0-70 wt % hydrophobic mesoporous nanoparticles, and 30-50 wt % polymer matrixes, with respect to the total composite composition.

10. The getter of claim 1, wherein the substrate is selected from the group consisting of Kovar, aluminum alloy, alumina, borosilicate glass with a preferred thickness of 100 μm to 200 μm, or a metal wire made of copper, aluminum, titanium, nickel, or other alloys, with diameters ranging from 100 μm to several millimeters.

11. The getter of claims 1-3, wherein the hydrophilicity-dominant polymer composite is optimized to primarily absorb at least polar and polar-dominant HCs and VOCs, while also adsorbing small amounts of non-polar HCs and VOCs outgassed from microelectronic or electronic packages, devices, or modules.

12. The getter of claims 1-3, wherein the hydrophobicity-dominant polymer composite is optimized to primarily absorb at least non-polar and non-polar-dominant HCs and VOCs, while also capturing small quantities of polar HCs/VOCs outgassed from microelectronic or electronic packages, devices, or modules.

13. The getter of claims 1-3, wherein the hierarchical porous nanostructured polymer composites are fabricated by one or more methods selected from the group consisting of in-situ polymerization, sol-gel processing, and 3D printing.

14. A composition for producing a hierarchical porous nanostructured polymer composite, comprising:
at least one microporous nanoparticle material;
at least one mesoporous nanoparticle material; and
at least one polymer matrix material.

15. The composition of claim 14, wherein the microporous nanoparticle material has high hydrophilicity with a size of less than 100 nm, with a preferred range of 20-60 nm.

16. The composition of claim 14, wherein the mesoporous nanoparticle material has high hydrophobicity and has a size of less than 100 nm, with a preferred size range of 20-60 nm.

17. The composition of claim 14, wherein the polymer composite has high surface energy, enabling primarily for effective absorption of polar HCs and VOCs through its hydrophilic and sieving properties.

18. The composition of claim 14, wherein the polymer composite has low surface energy, enabling primarily for effective absorption of non-polar HCs/VOCs through its hydrophobic properties.

19. The composition of claim 14, wherein the polymer composite has a balanced surface energy for the absorption of both polar and non-polar HCs/VOCs, optimized by a balanced weight ratio of hydrophilic microporous nanoparticle material and hydrophobic mesoporous nanoparticle material.

20. The composition of claim 14, wherein the polymer composite has high adsorption capacities for both polar and non-polar HCs/VOCs through its hierarchical porous nanostructure, optimized by the weight ratio of micropores to mesopores.
